(19) United States
(12) Patent Application Publication
(10) Pub. No.: US 2025/0281362 A1
(43) Pub. Date: Sep. 11, 2025

(54) SINGLE-USE MULTI-COMPARTMENT BABY FORMULA POUCH

(71) Applicants: Victor Burtea, Irvine, CA (US); Alexander Burtea, Ladera Ranch, CA (US); Daniel Burtea, Whittier, CA (US)

(72) Inventors: Victor Burtea, Irvine, CA (US); Alexander Burtea, Ladera Ranch, CA (US); Daniel Burtea, Whittier, CA (US)

(21) Appl. No.: 19/214,361

(22) Filed: May 21, 2025

Related U.S. Application Data
(63) Continuation-in-part of application No. 18/506,661, filed on Nov. 10, 2023.

(51) Int. Cl. A61J 9/00; A61J 9/04; A61J 11/00; A61J 11/04; B65D 81/32

(52) U.S. Cl. CPC A61J 9/005; A61J 9/04; A61J 11/002; A61J 11/008; A61J 11/045; B65D 81/3266; B65D 2221/00

(57) ABSTRACT

A single-use, multi-compartment infant formula pouch is disclosed. The pouch includes a substantially flat, flexible body formed from a laminate material including an aluminum foil layer. It contains two internal compartments: one pre-filled with powdered infant formula and the other with purified or distilled water. The compartments are separated by a frangible heat seal that ruptures upon applied pressure, enabling mixing just prior to use. The pouch also includes an integrated silicone nipple sealed beneath a removable cap, with the nipple secured into a spout by an internal locking ring to prevent user disassembly. During manufacturing, the pouch is filled under sterile conditions, including nitrogen gas injection and humidity control, to ensure long shelf life and inhibit microbial growth. The result is a tamper-evident, ready-to-feed, disposable system requiring no additional components or assembly.

### BACKGROUND

Pouches configured for holding liquids are well-known in the prior art patent literature.

For example, U.S. Pat. No. 7,810,677 discloses a flexible pouch defining a variable volume storage chamber and one-way valve assembly for aseptically storing a substance, dispensing multiple portions of the stored substance therefrom in cooperation with a pump, and maintaining substance remaining in the pouch in an aseptic condition sealed with respect to ambient atmosphere. The one-way valve includes a valve seat and elastic valve cover portion overlying the valve seat forming an interference fit therewith defining a normally-closed seam therebetween. The valve portion is movable radially between (i) a normally closed position with the valve portion engaging the valve seat, and (ii) an open position with at least a segment of the valve portion spaced radially away from the valve seat to allow substance from the storage chamber through the valve opening. The one-way valve maintains substance remaining in the variable-volume storage chamber in an aseptic condition sealed with respect to the ambient atmosphere.

Containers specialized for infant formula have also been described. For example, US20140299598 describes a container comprising: a body having a bottom and a side wall defining a reservoir; a collar attached to a top end of the body; a removable seal at the top end of the body to seal the reservoir; and, a lid hingedly engaged with the collar, the lid having an underside and configured to provide a docking station on the underside for holding a measuring device.

Nevertheless, convenient containers for holding powdered infant formula have continued to be elusive.

### SUMMARY OF INVENTION

Therefore, the present invention provides a convenient multi-compartment baby formula pouch with a compartment for powdered formula and compartment for liquid to mix with the formula.

According to an aspect of the present invention, there is provided a multi-compartment baby formula pouch, comprising: a foil pouch; a chamber containing a formula in powder form; a chamber containing a liquid; and a frangible seal, wherein the frangible seal is broken when pressure is applied allowing the powder and the liquid to mix.

### BRIEF DESCRIPTION OF THE DRAWINGS

FIG. 1 illustrates a perspective view of the multi-compartment baby formula pouch according to an embodiment of the present invention.

FIG. 2 illustrates a side view of the multi-compartment baby formula pouch according to an embodiment of the present invention.

FIG. 3 illustrates a cross-sectional view of the multi-compartment baby formula pouch according to an embodiment of the present invention.

FIG. 4 illustrates an exploded view of the spout for the multi-compartment baby formula pouch.

FIG. 5 illustrates the spout assembled.

### DETAILED DESCRIPTION

The present invention discloses a disposable, single-use infant formula pouch engineered to combine dry formula and sterile water within a sealed, flexible package that is ready for immediate use. The pouch includes two internal chambers separated by a frangible heat seal that ruptures cleanly when pressure is applied, allowing contents to mix prior to feeding. Unlike existing multi-part bottles or pouches requiring threaded fitments or assembly, this invention incorporates a silicone nipple pre-secured into a plastic spout by an internal locking ring. The spout is then heat-sealed directly to the pouch, forming a tamper-proof unit.

The pouch body is composed of a laminated film including an aluminum foil layer for moisture and light barrier protection. During manufacturing, powdered infant formula is dispensed into a first chamber under dehumidified conditions to prevent microbial contamination. A second chamber is filled with purified or distilled water, often in a separate room, and both chambers are purged with nitrogen gas to displace oxygen and extend shelf stability. This separation, paired with a clean-break heat seal and nitrogen environment, ensures the safety, sterility, and shelf-life of the pre-filled pouch.

A removable cap covers the spout and nipple, keeping the feeding tip sterile until use. Once the internal seal is broken by manual squeezing and the pouch is shaken to mix contents, the cap is removed and the infant may feed directly from the pouch. No further assembly, sterilization, or transfer of ingredients is required.

Typically, infant formula is a granulated or powder product packaged dry in a container. It is often difficult to use the container and dispense the powder formula from the container. Once the container is opened, the powdered formula is often packed into parts of the interior of the lid or top of the container, which results in waste. While some of the powder may fall back into the interior of the container, much of it is wasted and contaminated as it spills onto the surrounding workspace. Additionally, prior art containers may allow the contents to become contaminated.

The present invention provides a superior method of storing and dispensing infant formula. It has a unique silicone nipple and a unique plastic holder. It has a type of aluminum foil for the pouch section with a “frangible seal” that will burst open once pressure is applied to it. One compartment will have distilled water, and the other section will have the baby formula.

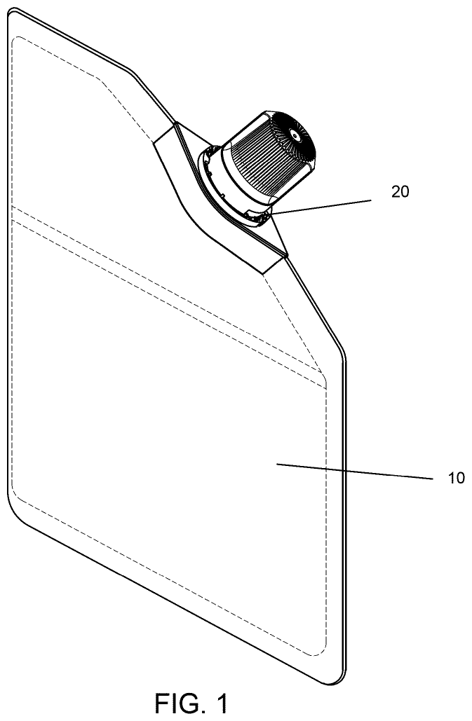

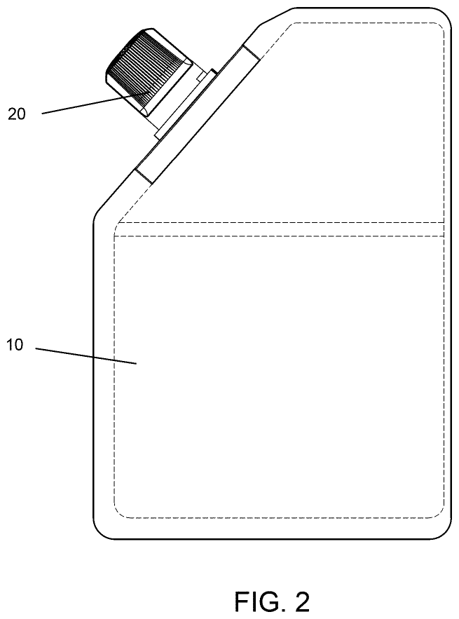

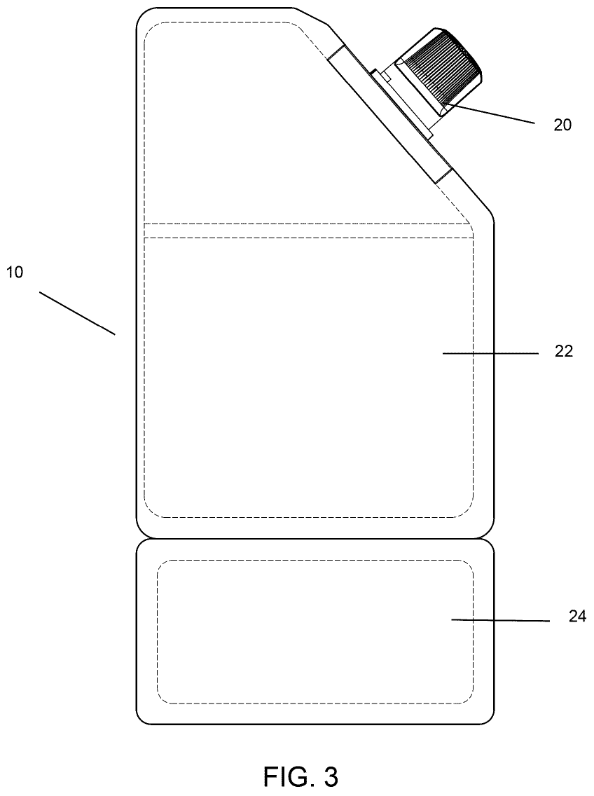

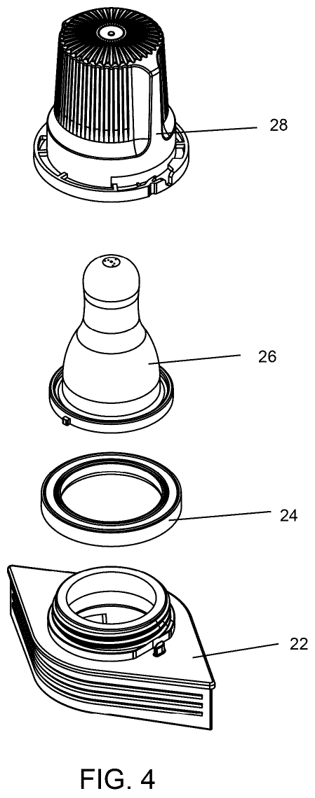

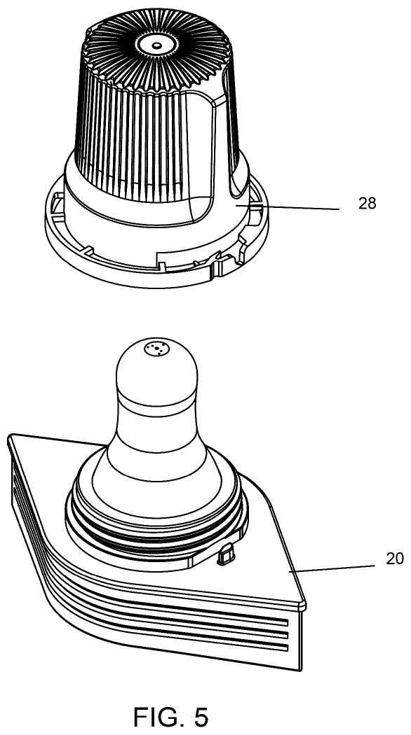

The following reference numerals are indicated in FIGS. 1-5:
10—pouch
12—upper section
14—lower section
20—cap
22—connector of pouch and spout
24—o ring
26—spout
28—cover for spout

Pouch 10 is topped by cap which covers a silicone nipple. Pouch 10 has two compartments, one for liquid storage 12 and one for powder storage 14, which are separated by frangible seal. Pouch 10 can be of aluminum foil, for example.

Liquid storage 12 typically will contain distilled water, but in some embodiments may contain bottled or tap water or another liquid.

Powder storage 14 contains powdered formula. Powdered formula is designed to be mixed with a specified amount of water before being consumed by an infant. It is typically difficult to use the exact amount of water and formula listed on the formula container instructions, and the present invention addresses that difficulty very well.

A frangible seal separates the liquid and the powder. Frangible seal is configured to open when pressure is applied.

A holder can be plastic or a similar material, for example. The holder is configured to receive a silicone nipple and cap.

The silicone nipple can be food-grade silicone, for example, which is a safe, durable and hygienic material for baby bottle nipples. Natural rubber nipples or synthetic latex nipples may be used in other embodiment.

In an alternate embodiment, a silicone nipple and nipple holder are silicone and are merged into one piece.

Silicone nipple can connect to nipple holder by a notch or other connecting member. Silicone nipple can screw or snap on to nipple holder or be connected in another fashion.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Similar numerals designate similar elements among the several figures. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A disposable, single-use infant feeding pouch comprising:
a) a substantially flat, flexible pouch comprising a laminate including an aluminum foil barrier layer;
b) a first compartment pre-filled with powdered infant formula;
c) a second compartment pre-filled with purified or distilled water;
d) a frangible heat seal separating the first and second compartments, wherein the seal is configured to rupture upon application of internal pressure, allowing the contents to mix;
e) a pre-attached feeding assembly comprising:
i. a silicone nipple inserted into a plastic spout from below;
ii. an internal locking ring or structure that secures the nipple within the spout and prevents user removal; and
iii. a removable protective cap covering the nipple and spout;
f) wherein the pouch is pre-filled and sealed during manufacturing in an environment that maintains dryness in the powdered formula compartment and includes nitrogen gas injection into both compartments to displace moisture and oxygen;
g) and wherein the pouch is self-contained, structurally independent of any external bottle or holder, and fully assembled for immediate feeding use without user modification.

2. The pouch of claim 1, wherein the frangible seal is a residue-free heat seam that opens cleanly when internal pressure exceeds a predetermined threshold.

3. The pouch of claim 1, wherein the first compartment is filled in a dehumidified zone to limit ambient moisture exposure to the powdered infant formula.

4. The pouch of claim 1, wherein the nitrogen gas is injected into both compartments after filling to reduce oxygen and inhibit microbial growth.

5. The pouch of claim 1, wherein the aluminum foil layer is configured to prevent light and moisture penetration for increased shelf stability.

6. The pouch of claim 1, wherein the entire feeding assembly including nipple, spout, and cap is permanently affixed to the pouch by heat sealing, ultrasonic welding, or adhesive bonding.

7. The pouch of claim 1, further comprising a tamper-evident band over the removable cap.

8. The pouch of claim 1, wherein the pouch shape includes ergonomic features or perforated grip zones to facilitate pressure application for seal rupture.

9. The pouch of claim 1, wherein the nipple includes a one-way valve to prevent reverse flow during feeding.

10. The pouch of claim 1, wherein the spout includes an integrated air vent for pressure equalization during infant feeding.

11. The pouch of claim 1, wherein the powder and water compartments are filled in physically separated environments to prevent cross-contamination during manufacturing.
